(19) United States
(12) Patent Application Publication
(10) Pub. No.: US 2019/0385054 A1
(43) Pub. Date: Dec. 19, 2019

(54) TEXT FIELD DETECTION USING NEURAL NETWORKS

(71) Applicant: ABBYY Production LLC, Moscow (RU)

(72) Inventors: Konstantin Zuev, Moscow (RU); Oleg Senkevich, Ivanovo (RU); Sergei Golubev, Moscow (RU)

(21) Appl. No.: 16/017,683

(22) Filed: Jun. 25, 2018

(30) Foreign Application Priority Data
Jun. 18, 2018 (RU) 2018122092

(51) Int. Cl. G06N 3/08; G06F 17/27

(52) U.S. Cl. CPC G06N 3/08; G06F 17/2785; G06F 17/2765; G06F 17/2735

(57) ABSTRACT

Aspects of the disclosure provide for mechanisms for character recognition using neural networks. A method of the disclosure includes extracting a plurality of features from an electronic document, the plurality of features comprising a plurality of symbolic vectors representative of words in the electronic document; processing the plurality of features using a neural network; detecting, by a processing device, a plurality of text fields in the electronic document based on an output of the neural network; and assigning, by the processing device, each of the plurality of text fields to one of a plurality of field types based on the output of the neural network.

### RELATED APPLICATIONS

This application claims priority to Russian Patent Application No.: RU2018122092, filed Jun. 18, 2018, the entire contents of which are hereby incorporated by reference herein.

### TECHNICAL FIELD

The implementations of the disclosure relate generally to computer systems and, more specifically, to systems and methods for detecting text fields in electronic documents using neural networks.

### BACKGROUND

Detecting text fields in an electronic document is a foundational task in processing electronic documents. Conventional approaches for field detection may involve the use of a large number of manually configurable heuristics and may thus require a lot of manual labor.

### SUMMARY OF THE DISCLOSURE

Embodiments of the present disclosure describe mechanisms for detecting text fields in electronic documents using neural networks. A method of the disclosure includes extracting a plurality of features from an electronic document, the plurality of features comprising a plurality of symbolic vectors representative of words in the electronic document; processing the plurality of features using a neural network; detecting, by a processing device, a plurality of text fields in the electronic document based on an output of the neural network; and assigning, by the processing device, each of the plurality of text fields to one of a plurality of field types based on the output of the neural network.

A system of the disclosure includes: a memory; and a processing device operatively coupled to the memory, the processing device to: extract a plurality of features from an electronic document, the plurality of features comprising a plurality of symbolic vectors representative of words in the electronic document; process the plurality of features using a neural network; detect a plurality of text fields in the electronic document based on an output of the neural network; and assign each of the plurality of text fields to one of a plurality of field types based on the output of the neural network.

A non-transitory machine-readable storage medium of the disclosure includes instructions that, when accessed by a processing device, cause the processing device to: extract a plurality of features from an electronic document, the plurality of features comprising a plurality of symbolic vectors representative of words in the electronic document; process the plurality of features using a neural network; detect a plurality of text fields in the electronic document based on an output of the neural network; and assign each of the plurality of text fields to one of a plurality of field types based on the output of the neural network.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 is an example of a computer system in which implementations of the disclosure may operate;

FIG. 2 is a schematic diagram illustrating an example of a neural network in accordance with some embodiments of the present disclosure;

FIG. 3 is a schematic diagram illustrating an example of a mechanism for producing character-level word embeddings in accordance with some embodiments of the present disclosure;

FIG. 4 is a schematic diagram illustrating an example of a fourth plurality of layers of the neural network of FIG. 2 in accordance with some embodiments of the present disclosure;

FIGS. 5A, 5B, and 5C are schematic diagrams illustrating an example of a mechanism for calculating features maps including word features in accordance with some embodiments of the present disclosure;

FIG. 6 is a flow diagram illustrating a method for detecting text fields in an electronic document in accordance with some embodiments of the present disclosure;

FIG. 7 is a flow diagram illustrating a method for detecting text fields using a neural network in accordance with some embodiments of the present disclosure; and

FIG. 8 illustrates a block diagram of a computer system in accordance with some implementations of the present disclosure.

### DETAILED DESCRIPTION

Embodiments for detecting text fields in electronic documents using neural networks are described. One algorithm for identifying fields and corresponding field types in an electronic document is the heuristic approach. In the heuristic approach, a large number (e.g., hundreds) of electronic documents, such as restaurant checks or receipts, for example, are taken and statistics are accumulated regarding what text (e.g., keywords) is used next to a particular field and where this text can be placed relative to the field (e.g., to the right, left, above, below). For example, the heuristic approach tracks what word or words are typically located next to the field indicating the total purchase amount, what word or words are next to the field indicating applicable taxes, what word or words are written next to the field indicating the total payment on a credit card, etc. On the basis of these statistics, when processing a new check, it can be determined which data detected on the electronic document corresponds to a particular field. The heuristic approach does not always work precisely, however, because if for some reason a check has been recognized with errors, namely in the word combinations “TOTAL TAX” and “TOTAL PAID” the words “tax” and “paid” were poorly recognized, the corresponding values might be miscategorized.

Aspects of the disclosure address the above noted and other deficiencies by providing mechanisms for identification of text fields in electronic documents using neural networks. The mechanisms can automatically detect text fields contained in an electronic document and associate each of the text fields with a field type. As used herein, “text field” may refer to a data field in an electronic document that contains text. As used herein, “field type” may refer to a type of content included in a text filed. For example, a field type may be “name,” “company name,” “telephone,” “fax,” “address,” etc.

As used herein, “electronic document” may refer to a file comprising one or more digital content items that may be visually rendered to provide a visual representation of the electronic document (e.g., on a display or a printed material). In accordance with various implementations of the present disclosure, an electronic document may conform to any suitable file format, such as PDF, DOC, ODT, etc.

The mechanisms may train a neural network to detect text fields in electronic documents and classify the text fields into predefined classes. Each of the predefined classes may correspond to a field type. The neural network may include multiple neurons that are associated with learnable weights and biases. The neurons may be arranged in layers. The neural network may be trained on a training dataset of electronic documents including known text fields. For example, the training data set may include examples of electronic documents comprising one or more text fields as training inputs and one or more field type identifiers that correctly correspond to the one or more fields as target outputs. The neural network may generate an observed output for each training input. The observed output of the neural network is compared with a target output corresponding to the target input as specified by the training data set, and the error is propagated back to the previous layers of the neural network, in which, parameters of the neural network (e.g., the weights and biases of the neurons) are adjusted accordingly. During the training of the neural network, the parameters of the neural network may be adjusted to optimize prediction accuracy.

Once trained, the neural network may be used for automatic detection of text fields in an input electronic document and to select the most probable field type of each of the text fields. The use of neural networks prevents the need for manual markup of text fields and field types on electronic documents. The techniques described herein allow for automatic detection of text fields in electronic documents using artificial intelligence. Using the mechanisms described herein to detect text fields in an electronic document may improve the quality of detection results by performing field detection using a trained neural network that preserves spatial information related to the electronic document. The mechanisms can be easily applied to any type of electronic document. Further, the mechanisms described herein may enable efficient text field detection and may improve processing speed of a computing device.

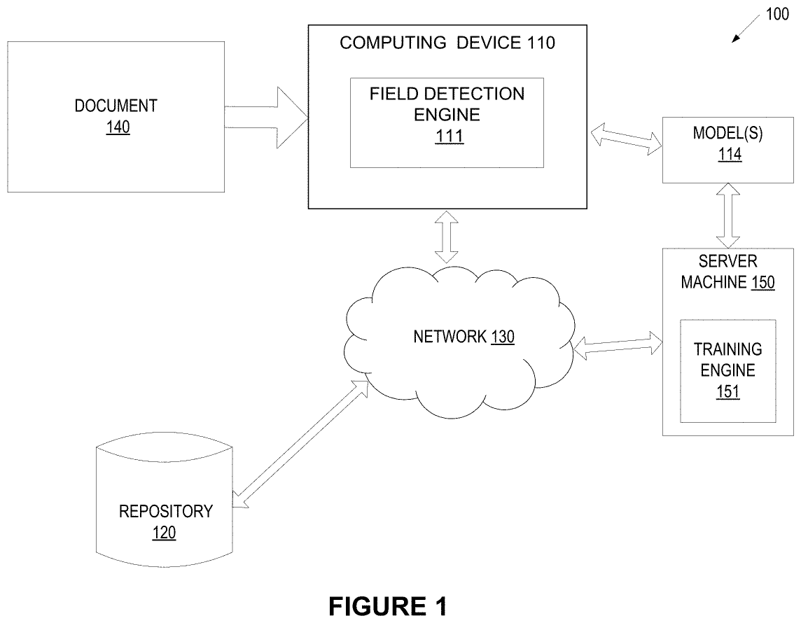

FIG. 1 is a block diagram of an example of a computer system 100 in which implementations of the disclosure may operate. As illustrated, system 100 can include a computing device 110, a repository 120, and a server device 150 connected to a network 130. Network 130 may be a public network (e.g., the Internet), a private network (e.g., a local area network (LAN) or wide area network (WAN)), or a combination thereof.

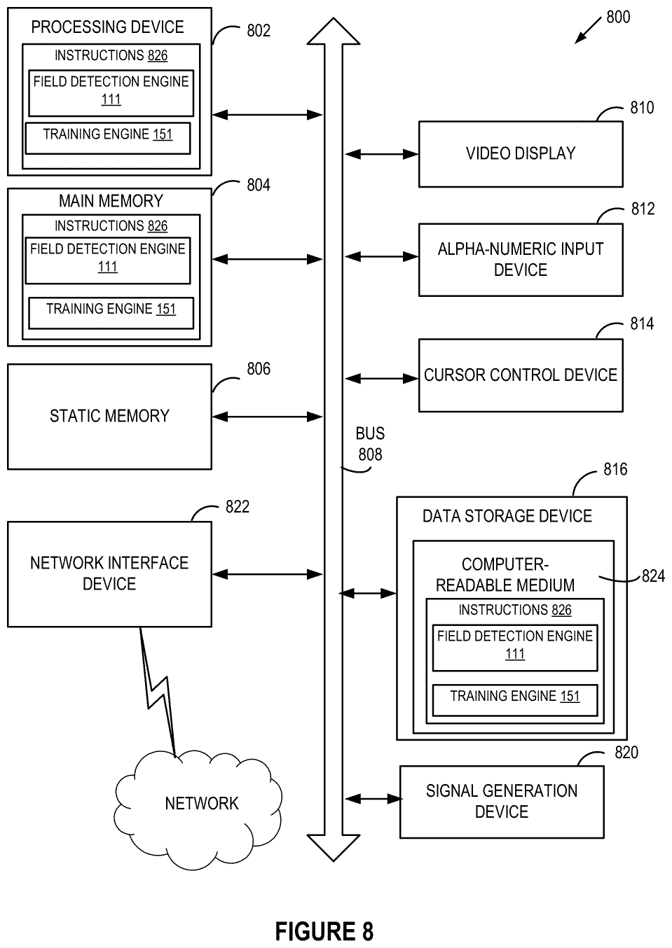

The computing device 110 may be a desktop computer, a laptop computer, a smartphone, a tablet computer, a server, a scanner, or any suitable computing device capable of performing the techniques described herein. In some embodiments, the computing device 110 can be and/or include one or more computing devices 800 of FIG. 8.

An electronic document 140 may be received by the computing device 110. The electronic document 140 may include any suitable text, such as one or more characters, words, sentences, etc. The electronic document 140 may be of any suitable type, such as “business card,” “invoice,” “passport,” “medical policy,” “questionnaire,” etc. The type of the electronic document 140 may be defined by a user in some embodiments.

The electronic document 140 may be received in any suitable manner. For example, the computing device 110 may receive a digital copy of the electronic document 140 by scanning a document or photographing the document. Additionally, in instances where the computing device 110 is a server, a client device connected to the server via the network 130 may upload a digital copy of the electronic document 140 to the server. In instances where the computing device 110 is a client device connected to a server via the network 130, the client device may download the electronic document 140 from the server.

The electronic document 140 may be used to train a set of machine learning models or may be a new electronic document for which text field detection and/or classification is desired. Accordingly, in the preliminary stages of processing, the electronic document 140 can be prepared for training the set of machine learning models or subsequent recognition. For instance, in the electronic document 140, text lines may be manually or automatically selected, characters may be marked, text lines may be normalized, scaled and/or binarized. In some embodiments, text in the electronic document 140 may be recognized using any suitable optical character recognition (OCR) technique.

In one embodiment, computing device 110 may include a field detection engine 111. The field detection engine 111 may include instructions stored on one or more tangible, machine-readable storage media of the computing device 110 and executable by one or more processing devices of the computing device 110. In one embodiment, the field detection engine 111 may use a set of trained machine learning models 114 for text field detection and/or classification. The machine learning models 114 are trained and used to detect and/or classify text fields in an input electronic document. The field detection engine 111 may also preprocess any received electronic documents prior to using the electronic documents for training of the machine learning model(s) 114 and/or applying the trained machine learning model(s) 114 to the electronic documents. In some instances, the trained machine learning model(s) 114 may be part of the field detection engine 111 or may be accessed on another machine (e.g., server machine 150) by the field detection engine 111. Based on the output of the trained machine learning model(s) 114, the field detection engine 111 may detect one or more text fields in the electronic document and can classify each of the text fields into one of a plurality of classes corresponding to predetermined field types.

The field detection engine 111 may be a client-based application or may be a combination of a client component and a server component. In some implementations, field detection engine 111 may execute entirely on the client computing device such as a tablet computer, a smart phone, a notebook computer, a camera, a video camera, or the like. Alternatively, a client component of field detection engine 111 executing on a client computing device may receive an electronic document and transmit it to a server component of the field detection engine 111 executing on a server device that performs the field detection and/or classification. The server component of the field detection engine 111 may then return a recognition result (e.g., a predicted field type of a detected text field) to the client component of the field detection engine 111 executing on the client computing device for storage or to provide to another application. In other implementations, field detection engine 111 may execute on a server device as an Internet-enabled application accessible via a browser interface. The server device may be represented by one or more computer systems such as one or more server machines, workstations, mainframe machines, personal computers (PCs), etc.

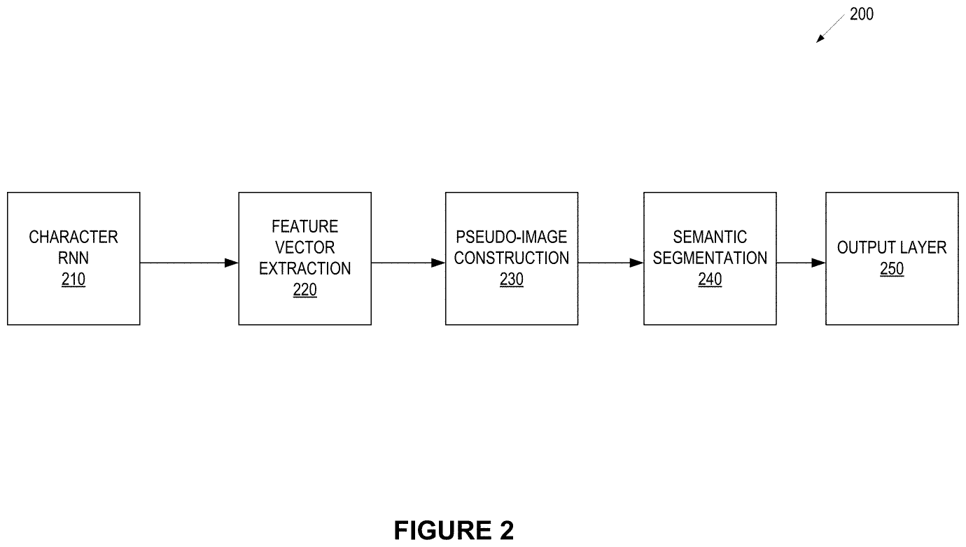

Server machine 150 may be and/or include a rackmount server, a router computer, a personal computer, a portable digital assistant, a mobile phone, a laptop computer, a tablet computer, a camera, a video camera, a netbook, a desktop computer, a media center, or any combination of the above. The server machine 150 may include a training engine 151. The training engine 151 can construct the machine learning model(s) 114 for field detection. The machine learning model(s) 114 as illustrated in FIG. 1 may refer to model artifacts that are created by the training engine 151 using training data that includes training inputs and corresponding target outputs (correct answers for respective training inputs). The training engine 151 may find patterns in the training data that map the training input to the target output (the answer to be predicted), and provide the machine learning models 114 that capture these patterns. As described in more detail below, the set of machine learning models 114 may be composed of, e.g., a single level of linear or non-linear operations (e.g., a support vector machine [SVM]) or may be a deep network, e.g., a machine learning model that is composed of multiple levels of non-linear operations. Examples of deep networks are neural networks including convolutional neural networks, recurrent neural networks with one or more hidden layers, and fully connected neural networks. In some embodiments, the machine learning model(s) 114 may include a neural network as described in connection with FIG. 2.

The machine learning model(s) 114 may be trained to detect text fields in the electronic document 140 and to determine the most probable field type for each of the text fields in the electronic document 140. For example, the training engine 151 can generate training data to train the machine learning model(s) 114. The training data may include one or more training inputs and one or more target outputs. The training data may also include mapping data that maps the training inputs to the target outputs. The training inputs may include a training set of documents including text (also referred to as the “training documents”). Each of the training documents may be an electronic document including a known text filed. The training outputs may be classes representing field types corresponding to the known text fields. For example, a first training document in the first training set may include a first known text field (e.g., “John Smith”). The first training document may be a first training input that can be used to train the machine learning model(s) 114. The target output corresponding to the first training input may include a class representing a field type of the known text filed (e.g., “name”). During the training of the initial classifier, the training engine 151 can find patterns in the training data that can be used to map the training inputs to the target outputs. The patterns can be subsequently used by the machine learning model(s) 114 for future predictions. For example, upon receiving an input of unknown text fields including unknown text (e.g., one or more unknown words), the trained machine learning model(s) 114 can predict a field type to which each of the unknown text fields belongs and can output a predicted class that identifies the predicted field type as an output.

In some embodiments, the training engine 151 may train an artificial neural network that comprises multiple neurons to perform field detection in accordance with the present disclosure. Each neuron receives its input from other neurons or from an external source and produces an output by applying an activation function to the sum of weighted inputs and a trainable bias value. A neural network may include multiple neurons arranged in layers, including an input layer, one or more hidden layers, and an output layer. Neurons from adjacent layers are connected by weighted edges. The edge weights are defined at the network training stage based on a training dataset that includes a plurality of electronic documents with known classification. In an illustrative example, all the edge weights are initialized to random values. For every input in the training dataset, the neural network is activated. The observed output of the neural network is compared with the desired output specified by the training data set, and the error is propagated back to the previous layers of the neural network, in which the weights are adjusted accordingly. This process may be repeated until the output error satisfies a predetermined condition (e.g., falling below a predetermined threshold). In some embodiments, the artificial neural network may be and/or include a neural network 200 of FIG. 2.

Once the machine learning model(s) 114 are trained, the set of machine learning model(s) 114 can be provided to field detection engine 111 for analysis of new electronic documents of text. For example, the field detection engine 111 may input the electronic document 140 and/or features of the electronic document 140 into the set of machine learning models 114. The field detection engine 111 may obtain one or more final outputs from the set of trained machine learning models and may extract, from the final outputs, a predicted field type of each of the text fields detected in the electronic document 140. The predicted field type may include a probable field type representing a type of a detected field (e.g., “name,” “address,” “company name,” “logo,” “email,” etc.).

In some embodiments, to generate the features of the electronic document 140 to be processed by the machine learning model(s) 114, the field detection engine 111 can recognize text in the electronic document 140 (e.g., using suitable character recognition methods) and can divide the text into multiple words. The field detection engine 111 can extract multiple character sequences from the words. Each of the character sequences may include a plurality of characters contained in the words. For example, the field detection engine 111 can convert the words into a plurality of first character sequences by processing each of the words in a first order (e.g., a forward order). The field detection engine 111 can also convert the words into a plurality of second character sequences by processing each of the words in a second order (e.g., a backward order). Each of the first character sequences may thus include a first plurality of characters corresponding to a second plurality of characters of a corresponding second character sequence in a reverse order. For example, the word “NAME” can be converted into character sequences of “NAME” and “EMAN.”

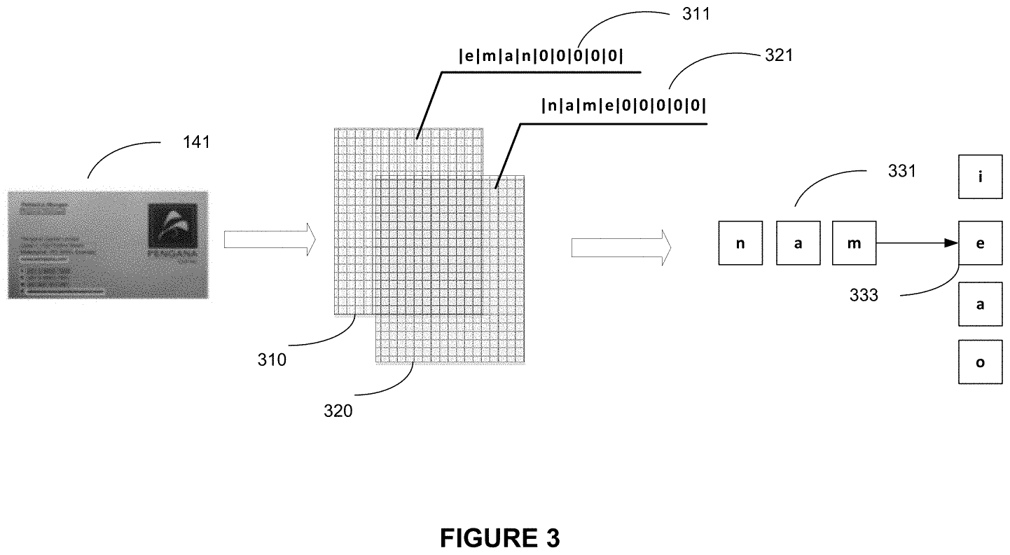

The field detection engine 111 can generate a plurality of feature vectors based on the character sequences. Each of the feature vectors may be a symbolic embedding of characters of one of the words. In one implementation, the field detection engine 111 can construct one or more tables including the character sequences. For example, as illustrated in FIG. 3, the first character sequences and the second character sequences may be entered into a suffix table 310 and a prefix table 320, respectively. Each column or row of the table may include a character sequence and may be regarded as a symbolic embedding of characters of a word. For example, a row 311 of the suffix table 310 may include a character sequence of “EMAN” extracted from the word “NAME” and may be regarded as a first symbolic embedding of the word “NAME.” A row 321 of the prefix table 320 may include a character sequence of “NAME” extracted from the word “NAME” and may be regarded as a second symbolic embedding of the word “NAME.” In some embodiments, each of the symbolic embeddings in the tables may have a certain length (e.g., a predetermined length). When the length of a character sequence is shorter than the certain length, predetermined values may be added to generate a symbolic embedding of the predetermine length (e.g., zeros added to empty columns or rows of the tables).

Referring back to FIG. 1, in some embodiments, the field detection engine 111 can use the machine learning model(s) 114 to generate hypotheses about spatial information of the text fields in the input document 140 and/or types of the text fields. The field detection engine 111 may evaluate the hypotheses to select the best combination of hypotheses for the whole electronic document. For example, the field detection engine 111 can choose the best (e.g., most likely to be correct) hypothesis, or sort the multiple hypotheses by an assessment of a quality (e.g., an indication of whether the hypotheses are correct).

The repository 120 is a persistent storage that is capable of storing electronic documents as well as data structures to perform character recognition in accordance with the present disclosure. Repository 120 may be hosted by one or more storage devices, such as main memory, magnetic or optical storage based disks, tapes or hard drives, NAS, SAN, and so forth. Although depicted as separate from the computing device 110, in an implementation, the repository 120 may be part of the computing device 110. In some implementations, repository 120 may be a network-attached file server, while in other embodiments content repository 120 may be some other type of persistent storage such as an object-oriented database, a relational database, and so forth, that may be hosted by a server machine or one or more different machines coupled to the via the network 130. The repository 120 may store training data in accordance with the present disclosure.

FIG. 2 is a schematic diagram illustrating an example 200 of a neural network in accordance with some embodiments of the present disclosure. The neural network 200 may include multiple neurons that are associated with learnable weights and biases. The neurons may be arranged in layers. As illustrated, neural network 200 may include a first plurality of layers 210, a second plurality of layers 220, a third plurality of layers 230, a fourth plurality of layers 240, and a fifth layer 250. Each of the layers 210, 220, 230, 240, and 250 may be configured to perform one or more functions for text field detection in accordance with the present disclosure.

The first plurality of layers 210 of the neural network 200 may include one or more recurrent neural networks. A recurrent neural network (RNN) is capable of maintaining the network state reflecting the information about the inputs which have been processed by the network, thus allowing the network to use their internal state for processing subsequent inputs. For example, the recurrent neural network may receive an input vector by an input layer of the recurrent neural network. A hidden layer of the recurrent neural network processes the input vector. An output layer of the recurrent neural network may produce an output vector. The network state may be stored and utilized for processing subsequent input vectors to make subsequent predictions.

The first plurality of layers 210 of the neural network 200 can be trained to produce vector representations of words (also referred to as “word vectors”). For example, the first plurality of layers 210 may receive an input representing a word and can map the word to a word vector (e.g., a word embedding). “Word embedding” as used herein may refer to a vector of real numbers or any other numeric representation of a word. A word embedding may be produced, for example, by a neural network implementing a mathematical transformation on words using embedding functions to map the words into numeric representations.

The input received by the first plurality of layers 210 may include features extracted from an electronic document as input. The features extracted from the electronic document may include, for example, a plurality of symbolic embeddings representative of words in the electronic document. In one implementation, the input may include a suffix table 310 and a prefix table 320 as described in connection with FIGS. 1 and 3. The word vector may be a character-level word embedding extracted from characters in the word. For example, the first plurality of layers 210 of the neural network 200 may be trained based on a predictive model that may predict a next character of a word (e.g., the character 333 as illustrated in FIG. 3) based on one or more previous characters of the word (e.g., the characters 331 as illustrated in FIG. 3). The prediction may be made based on parameters of the predictive model that correspond to a plurality of word embeddings. For example, the first plurality of layers 210 can take representations of a plurality of known words as input. The first plurality of layers 210 can then generate training inputs and training outputs based on the known words. In one implementation, the first plurality of layers 210 can convert each of the known words into one or more character sequences. Each of the character sequences may include one or more characters included in one of the known words. The first layer 210 can use a first plurality of characters and a second plurality of characters of the character sequences as the training inputs and the training output, respectively. For example, each of the first plurality of characters may correspond to a previous character in one of the known words (e.g., the first character of each of the known words, the first three characters of each of the known words, etc.). The second plurality of characters may correspond to a next character that is subsequent to the previous character. The predictive model may be used to predict the next character (e.g., the character “E” of the word “NAME”) based on one or more previous characters of the word (e.g., the characters “NAM” of the word “NAME”). The prediction may be made based on character-level embeddings assigned to the characters. Each of the character-level word embeddings may correspond to a vector in a continuous vector space. Similar words (e.g., semantically similar words) are mapped to nearby points in the continuous vector space. During the training process, the first plurality of layers 210 can find character-level embeddings that can optimize the probability of a correct prediction of the next character based on the previous characters.

The second plurality of layers 220 of the neural network 200 can construct a data structure including features of the words (also referred to as the “first word features”). The data structure may be and/or include one or more tables (also referred to as the “first tables”) in some embodiments. Each of the first word features may relate to one or more of the words in the electronic document 140. In one implementation, the words in the electronic document may be entered into the cells of the first table(s). One or more feature vectors corresponding to each of the words can also be entered into the columns or rows of the first tables. In some embodiments, the table of word features may include a certain number of words. For example, a threshold number of words can be defined a given type of electronic document.

Each of the first word features may be and/or include any suitable representation of one or more features of one of the words. For example, the first word features may include the character-level word embeddings produced by the first plurality of layers 210. As another example, the first word features may include one or more word vectors associated with the words in an embedding dictionary. The embedding dictionary may include data about known words and their corresponding word vectors (e.g., word embeddings assigned to the words). The embedding dictionary may include any suitable data structure that can present associations between each of the known words and its corresponding word vectors, such as a table. The embedding dictionary may be generated using any suitable model or combination of models that can produce word embeddings, such as word2vec, GloVec, etc. In some implementations, the embedding dictionary may include vector representations of keywords pertaining to the type of the electronic document and may be a keyword dictionary including keywords pertaining to a particular type of electronic documents and their corresponding word embeddings. For example, keywords pertaining to a business card may include “telephone,” “fax,” common names and/or surnames, names of well-known companies, words specific to addresses, geographic names, etc. Different keyword dictionaries may be used to various types of electronic documents (e.g., “business card,” “invoice”, “passport,” “medical policy,” “questionnaire,” etc.

As still another example, the first word features may include information about one or more portions of the electronic documents containing the words. Each of the portions of the electronic document may include one or more of the words (e.g., a respective word, multiple words that are regarded as being related to each other, etc.). Each of the portions of the electronic documents may be a rectangular area or may have any other suitable shape. In one implementation, the information about the portions of the electronic documents containing the words may include spatial information of the portions on the image of the electronic document. Spatial information of a given portion of the electronic document containing a word may include one or more coordinates defining a location of the given portion of the electronic document. In another implementation, the information about the portions of the electronic document may include pixel information about the portions of the electronic document. The pixel information of a given portion of the electronic document containing a word may include, for example, one or more coordinates and/or any other information of the a pixel of the given portion of the electronic document (e.g., a central pixel or any other pixel of the portion of the image).

As yet another example, the first word features may include information about text formatting of the words (e.g., height and width of symbols, spacing, etc.). As still another example, the first word features may include information about proximity and/or similarity of the words in the electronic document. In one implementation, the proximity of the words may be represented by a word neighborhood graph that is constructed based on data about the portions of the electronic document including the words (e.g., the projections of rectangular areas including words, a distance between the rectangular areas, etc.). In another implementation, word neighborhood information can be specified using a plurality of rectangles of words whose vertices are connected. The information about the similarity of the words may be determined based on a degree of similarity of character sequences. (e.g., by comparing the character sequences extracted from the words).

The third plurality of layers 230 of the neural network 200 can construct a pseudo-image based on the data structure including the first word features (e.g., the one or more first tables). The pseudo-image may represent a projection of the word features produced by the second layer 220. The pseudo-image may be an artificially created image of a certain size, such as a three-dimensional array of size hxwxd, wherein a first dimension h and a second dimension w are spatial dimensions, and a third dimension d represents a plurality of channels of the pseudo-image. Each of the words in the first tables may be assigned to a pixel of the pseudo-image. Each pixel of the pseudo-image may thus correspond to one of the words. The word features may be written into the plurality of channels of the pseudo-image. Accordingly, each pixel of the pseudo-image may further include spatial information of its corresponding word (e.g., pixel information of the corresponding word).

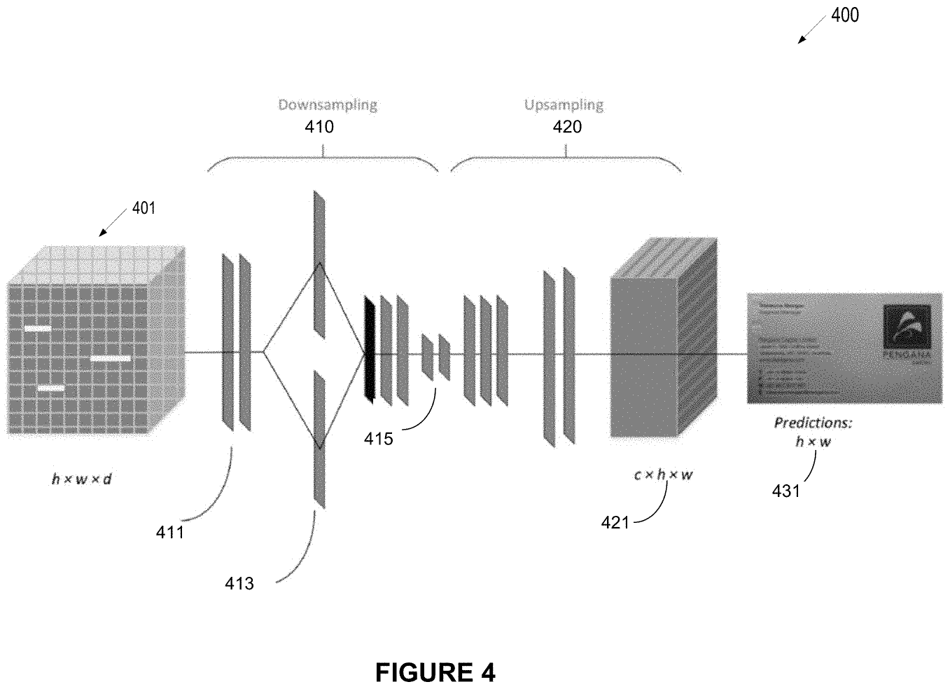

The fourth plurality of layers 240 of the neural network 200 can extract one or more features representative of the words from the pseudo-image (also referred to as the “second plurality of word features”). The fourth plurality of layers 240 can be and/or include one or more convolutional networks built on translation invariance. The convolutional networks may include one or more convolutional layers, pooling layers, and/or any other suitable components for extracting word features from the pseudo-image. A convolution layer may extract features from an input image by applying one or more trainable pixel-level filters (also referred to as the “convolution filters”) to the input image. A pooling layer may perform subsampling in order to produce a reduced resolution feature map while retaining the most relevant information. The subsampling may involve averaging and/or determining maximum value of groups of pixels. In some embodiments, the fourth plurality of layers 240 may include one or more layers as described in connection with FIG. 4.

In one implementation, the fourth plurality of layers 240 may perform semantic segmentation on the pseudo-image to extract the second plurality of word features. For example, the fourth plurality of layers 240 can process the pseudo-image to produce a compressed pseudo-image. The compressed pseudo-image may represent one or more first feature maps including information of field types of text fields present in the electronic document and their locations relative to each other. The compressed pseudo-image may be generated, for example, by processing the pseudo-image using one or more layers performing downsampling operations (also referred to as the “downsampling layers”). The downsampling layers may include, for example, one or more convolutional layers, subsampling layers, pooling layers, etc.

The fourth plurality of layers 240 may process the compressed pseudo-image to output one or more second feature maps including the second plurality of word features. The second feature maps may be generated by performing transposed convolution or one or more other upsampling operations on the compressed pseudo-image. In some embodiments, the semantic segmentation may be performed by performing one or more operations as described in connection with FIG. 4 below.

In some embodiments, the fourth plurality of layers 240 can generate and output one or more data structures including the second plurality of features. For example, the data structures may include one or more tables including the second plurality of word features (also referred to as the “second tables”).

The fifth layer 250 may classify each of the words into one of a plurality of predefined classes based the output of the fourth plurality of layers 240. Each of the predefined classes may correspond to one of the field types to be detected. The fifth layer 250 may produce an output of the neural network 200 indicative of results of the classification. As an example, the output of the neural network 200 may include a vector, each element of which specifies a degree of association of a word in the input electronic document with one of the predefined classes (e.g., a probability that the word belongs to the predefined class). As another example, the output of the neural network 200 may include one or more field type identifiers. Each of the field type identifiers may identify a field type associated with one of the words. In some embodiments, the fifth layer 250 may be a “fully connected” layer where every neuron in the previous layer is connected to every neuron on the next layer.

FIG. 4 illustrates an example architecture 400 of the fourth plurality of layers 240 of the neural network 200 in accordance with some embodiments of the present disclosure. As illustrated, the fourth plurality of layers 240 may include one or more downsampling layers 410 and upsampling layers 420. The downsampling layers 410 may further include one or more alternate convolution layers 411, separate convolution layers 413, and concatenation layer 415.

Each of the alternate convolution layers 411 and separate convolution layers 413 may be a convolution layer configured to extract features from an input electronic document by applying one or more trainable pixel-level filters (also referred to as the “convolution filters”) to the input image. A pixel-level filter may be represented by a matrix of integer values, which is convolved across the dimensions of the input electronic document in order to compute dot products between the entries of the pixel-level filter and the input electronic document at each spatial position, thus producing a feature map that represents the responses of the filter at every spatial position of the input electronic document.

In some embodiments, the alternate convolution layers 411 can receive a pseudo-image 401 as an input and extract one or more features from the pseudo-image 401 (e.g., a pseudo-image as described in conjunction with FIG. 2 above). The alternate convolution layers 411 can output one or more feature maps including the extracted features (also referred to as the “initial feature maps”). Each of the alternate convolution layers 411 may perform one or more convolution operations on the pseudo-image 401 to generate the initial feature maps. For example, an alternate convolution layer 411 can apply one or more convolution filters (also referred to as the “first convolution filters”) on the pseudo-image 401. Application of each of the convolution filters on the pseudo-image 401 may produce one of the initial feature maps. Each of the first convolution filters may be a matrix of pixels. Each of the first convolution filters may have a certain size defining by a width, height, and/or depth. The width and the height of the matrix may be smaller than the width and the height of the pseudo-image, respectively. The depth of the matrix may be the same as the depth of the pseudo-image in some embodiments. Each of the pixels of the first convolution filters may have a certain value. The first convolution filters may be trainable. For example, the number of the first convolution filters, parameters of each of the first convolution filters (e.g., the size of each of the first convolution filters, the values of the elements of each of the first convolution filters, etc.) may be learned during training of the neural network 200.

Applying a given convolution filter on the pseudo-image may involve computing a dot product between the given convolution filter and a portion of the pseudo-image. The portion of the pseudo-image may be defined by the size of the given convolution filter. The dot product between the given convolution filter and the portion of the pseudo-image may correspond to an element of the initial feature map. The alternate convolution layers 411 can generate a first feature map by convolving (e.g., sliding) the given convolution filter across the width and height of the pseudo-image 401 and computing dot products between the entries of the given filter and the pseudo-image at each spatial position of the pseudo-image. In some embodiments, the alternate convolution layers 411 can generate a plurality of initial feature maps by applying each of the filters to the pseudo-image 401 as described above and convolving (e.g., sliding) each of the filters across the width and height of the pseudo-image 401.

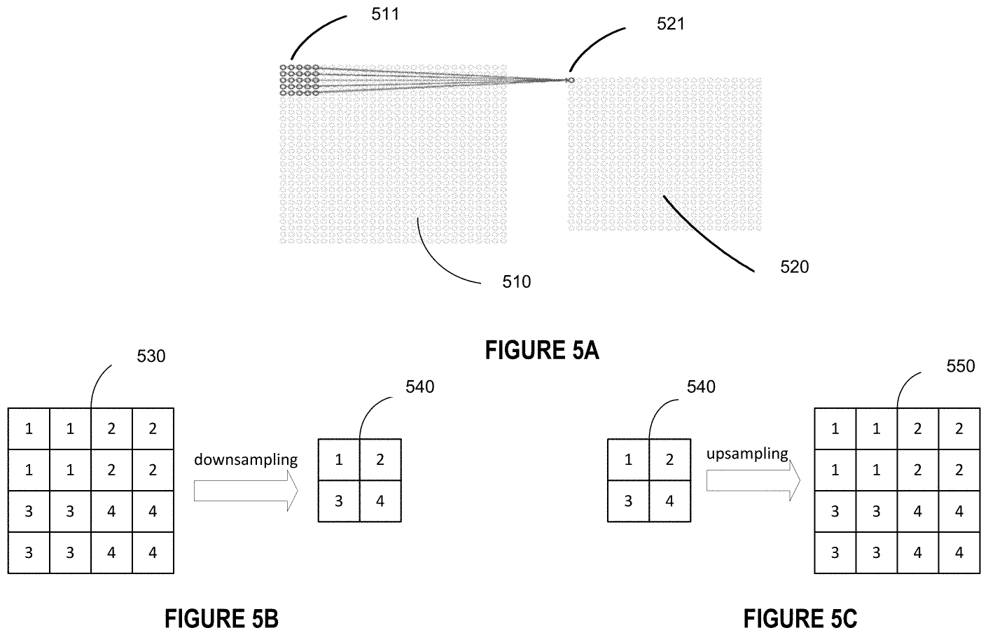

For example, as illustrated in FIG. 5A, a convolution filter 511 may be applied to a portion of the pseudo-image 510. More particularly, for example, the values of the filter 511 are multiplied by the pixel values of the portion of the pseudo-image and all these multiplications may be summed, resulting in an element 521 of a feature map 520. The element 520 may be a single number in some embodiments. The feature map 520 may represent the responses of the filter 511 at every spatial position of the pseudo-image 510.

Returning to FIG. 4, the separate convolution layers 413 can perform one or more convolution operations on each of the initial feature maps. Each of the convolution operations may involve applying a convolution filter (also referred to as the “second convolution filter”) to one of the initial feature maps produced by the alternate convolution layers 411, convolving (e.g., sliding) the second convolution filter across the width and height of the first feature map, and computing dot products between the entries of the second convolution filter and the initial feature map at each spatial position of the initial feature map. In some embodiments, the convolution operations may involve convolving (e.g., sliding the second convolution filter) across one or more of the first feature maps in different directions. For example, a first convolution operation and a second convolution operation may involve convolving the second convolution filter in a first direction (e.g., a horizontal direction) and a second direction (e.g., a vertical direction), respectively. As such, the separate convolution layers 413 may trace changes in the pseudo-image 401 occurring in different directions.

In some embodiments, the downsampling layers 410 may further include one or more pooling layers (not shown). A pooling layer may perform subsampling in order to produce a reduced resolution feature map while retaining the most relevant information. The subsampling may involve averaging and/or determining maximum value of groups of pixels. The pooling layers may be positioned between successive convolution layers 411 and/or 413. Each of the pooling layers may perform a subsampling operation on its input to reduce the spatial dimensions (e.g., width and height) of its input. For example, a given pooling layer may receive a feature map produced by a convolution layer as an input. The pooling layer can perform a mathematical operation on the feature map to search for the largest number in a portion of the input. In some embodiments, the pooling layer can apply a filter to the feature map with a predetermined stride to downsample the input feature map. The application of the filter across the feature map (e.g., by sliding the filter across the feature map) may produce a downsampled feature map. For example, as illustrated in FIG. 5B, a downsampled feature map 540 may be extracted from a feature map 530.

In some embodiments, the downsampling layers 410 may further include one or more dropout layers (not shown). The dropout layers may randomly remove information from the feature maps. As such, the dropout layers can improve over-fit of the neural network 200 and can avoid over-training of the neural network.

As illustrated in FIG. 4, the downsampling layers 410 further include the concatenation layer 415 where several layers of the downsampling layers 410 merge. The concatenation layer 415 may output a compressed pseudo-image representative of a combination of multiple feature maps generated by the downsampling layers 410 (also referred to as the “first feature maps”).

The upsampling layers 420 may include a plurality of layers configured to process the compressed pseudo-image to produce a reconstructed pseudo-image 421. The reconstructed pseudo-image may represent a combination of a plurality of second feature maps. Each of the first feature maps may have a first size (e.g., a first resolution). Each of the second feature maps may have a second size (e.g., a second resolution). The second size may be greater than the first size. In one implementation, the second size may be defined by the spatial dimensions of the input pseudo-image (h×w). As an example, the compressed pseudo-image may represent the pseudo-image downsampled by a factor off. The second feature maps may be generated by upsampling the compressed pseudo-image by the factor off. In some embodiments, the upsampling layers 420 can upsample the compressed pseudo-image by performing transpose convolution on the compressed pseudo-image. The transpose convolution may be performed by applying a deconvolution filter with a certain stride (e.g., a stride off). As an example, as shown in FIG. 5C, an input feature map 540 of 2×2 pixels may be upsampled to produce an upsampled feature map 550 of 4×4 pixels. Returning to FIG. 4, a segmentation output 431 may be generated based on the reconstructed pseudo-image. The segmentation output 431 may represent a segmented version of the electronic document 140 where words belonging to the same text field are clustered together. The segmentation output 431 may be produced by the fifth layer 250 of the neural network 200 of FIG. 2 in some embodiments.

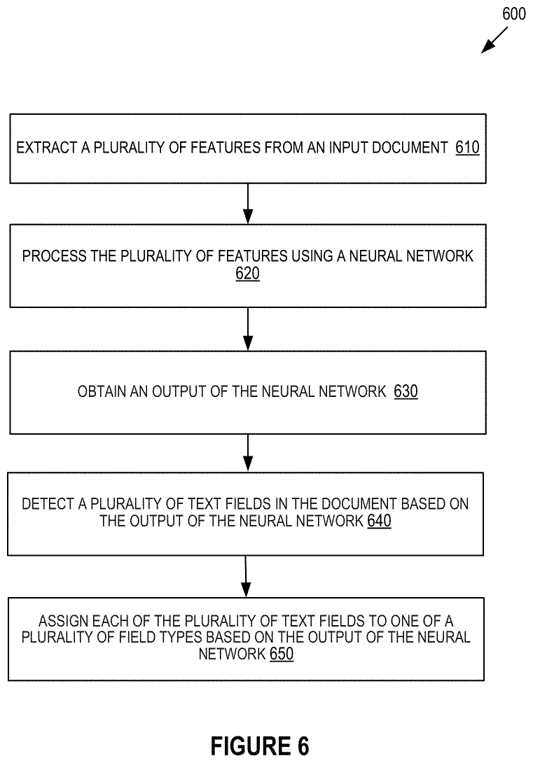

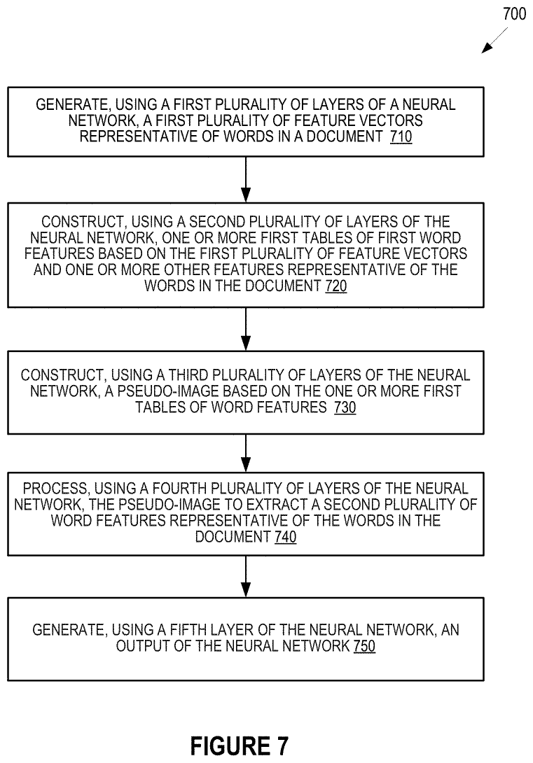

FIGS. 6 and 7 are flow diagrams illustrating methods 600 and 700 for field detection using a machine learning model according to some implementations of the disclosure. Each of methods 600 and 700 can be performed by processing logic that may comprise hardware (e.g., circuitry, dedicated logic, programmable logic, microcode, etc.), software (such as instructions run on a processing device), firmware, or a combination thereof. In one implementation, methods 600 and 700 may be performed by a processing device (e.g. a processing device 802 of FIG. 8) of a computing device 110 and/or a server machine 150 as described in connection with FIG. 1.

Referring to FIG. 6, method 600 may begin at block 610 where the processing device can extract a plurality of features from an input electronic document. The input electronic document may be an electronic document 140 as described in connection with FIG. 1. The features of the input electronic document may include one or more feature vectors representative of the words. Each of the feature vectors may be a symbolic embedding representing one or more of the words. For example, to generate the feature vectors, the processing device can recognize text in the image and can divide the text in the image into a plurality of words. Each of the words may then be converted into one or more character sequences. In one implementation, the processing device can generate a plurality of first character sequences by processing each of the words in a first order (e.g., reading the words in a forward order). The processing device can also generate a plurality of second character sequences by processing each of the words in a second order (e.g., reading the words in a backward order). The processing device can then generate a first table by writing the words into the first table character-by-character in the first order. The processing device can also generate a second table by writing the words into the second table character-by-character in the second order. The processing device can then generate a plurality of symbolic embeddings based on the character sequences. For example, the processing device can generate a first symbolic embedding by entering the first character into the first table. The processing device can generate a second symbolic embedding by entering the second character into the second table.

At block 620, the processing device can process the plurality of features using a neural network. The neural network may be trained to detect text fields in a electronic document and/or determine field types of the text fields. The neural network may include a plurality of layers as described in connection with FIGS. 3 and 4 above. In some embodiments, the features may be processed by performing one or more operations described in connection with FIG. 7.

At block 630, the processing device can obtain an output of the neural network. The output of the neural network may include classification results indicative of a probable field type of each text field in the electronic document, such as a probability that a particular word in the electronic document belongs to one of a plurality of predefined classes. Each of the predefined classes corresponds to a field type to be predicted.

At block 640, the processing device can detect a plurality of text fields in the electronic document based on the output of the neural network. For example, the processing device can cluster the words in the electronic document based on their proximity to each other and their corresponding field types. In one implementation, the processing device can cluster one or more neighboring words that belong to the same field type together (e.g., clustering adjacent words “John” and “Smith” together, each of which belongs to the field type of “name”). The electronic document may be segmented into data fields based on the clustering of the words.

At block 650, the processing device can assign each of the plurality of text fields to one of a plurality of field types based on the output of the neural network. For example, the processing device can assign each of the text fields to a field type corresponding to the predefined class associated with the words in the text field.

Referring to FIG. 7, method 700 may begin at block 710 where a processing device can generate, using a first plurality of layers of a neural network, a first plurality of feature vectors representative of words in an electronic document. The first plurality of feature vectors may be generated based on a plurality of features extracted from the electronic document (e.g., the features extracted at block 610 of FIG. 6). For example, the first plurality of layers may extract a plurality of word embeddings representative of the words from the features of the electronic document. The word embeddings may include, for example, one or more character-level word embeddings produced by layers 210 of the neural network 200 as described in connection with FIG. 2 above.

At block 720, the processing device can construct, using a second plurality of layers of the neural network, one or more first tables of word features based on the first plurality of feature vectors and one or more other features representative of the words in the electronic document. The first tables include a first plurality of word features representative of the words in the electronic document. Each of the first plurality of word features may be one of the first plurality of feature vectors or the other features representative of the words in the electronic document. The one or more other features representative of the words in the electronic document may include a second plurality of feature vectors representative of the words in the electronic document. The second plurality of feature vectors may include, for example, a plurality of word vectors in an embedding dictionary that are assigned to the words in the electronic document, a plurality of word vectors in a keyword dictionary that are associated with the words in the electronic document, etc. The one or more other features representative of the words may also include features representing spatial information of one or more portions of the electronic document containing the words. Each of the portions of the electronic documents may be a rectangular area or any other suitable portion of the electronic document that contains one or more of the words. The spatial information of a given portion of the electronic document including one or more of the words may include, for example, one or more spatial coordinates defining the given portion of the electronic document, pixel information of the given portion of the electronic document (e.g., one or more spatial coordinates of a central pixel of the given portion of the electronic document), etc. The first tables include a first plurality of word features representative of the words in the electronic document. In some embodiments, each row or column of each of the first tables may include a vector or other representation of one of the first plurality of word features (e.g., one of the first plurality of feature vectors, one of the second plurality of feature vectors, etc.).

At block 730, the processing device can construct, using a third plurality of layers of the neural network, a pseudo-image based on the one or more first tables of first word features. The pseudo-image may be a three-dimensional array having a first dimension defining a width of the pseudo-image, a second dimension defining a height of the pseudo-image, and a third dimension defining a plurality of channels of the pseudo-image. Each pixel in the pseudo-image may correspond to one of the words. The word features may be written into the plurality of channels of the pseudo-image.

At block 740, the processing device can process, using a fourth plurality of layers of the neural network, the pseudo-image to extract a second plurality of word features representative of the words in the electronic document. For example, the fourth plurality of layers of the neural network can perform semantic segmentation on the pseudo-image to extract the second plurality of word features. More particularly, for example, the fourth plurality of layers of the neural network can perform one or more downsampling operations on the pseudo-image to produce a compressed pseudo-image. The compressed pseudo-image may represent a combination of a first plurality of feature maps including features representative of the words. The fourth plurality of layers of the neural network can then perform one or more upsampling operations on the compressed pseudo-image to produce a reconstructed pseudo-image. The reconstructed pseudo-image may represent a combination of a second plurality of feature maps including the second plurality of features representative of the words. In some embodiments, the processing device can also construct one or more second tables including the second plurality of features representative of the words.

At block 750, the processing device can generate, using a fifth layer of the neural network, an output of the neural network. The fifth layer of the neural network may be a fully-connected layer of the neural network. The output of the neural network may include information about a predicted class that identifies a predicted field type of each of the words in the electronic document.

FIG. 8 depicts an example computer system 800 which can perform any one or more of the methods described herein. The computer system may be connected (e.g., networked) to other computer systems in a LAN, an intranet, an extranet, or the Internet. The computer system may operate in the capacity of a server in a client-server network environment. The computer system may be a personal computer (PC), a tablet computer, a set-top box (STB), a Personal Digital Assistant (PDA), a mobile phone, a camera, a video camera, or any device capable of executing a set of instructions (sequential or otherwise) that specify actions to be taken by that device. Further, while only a single computer system is illustrated, the term “computer” shall also be taken to include any collection of computers that individually or jointly execute a set (or multiple sets) of instructions to perform any one or more of the methods discussed herein.

The exemplary computer system 800 includes a processing device 802, a main memory 804 (e.g., read-only memory (ROM), flash memory, dynamic random access memory (DRAM) such as synchronous DRAM (SDRAM)), a static memory 806 (e.g., flash memory, static random access memory (SRAM)), and a data storage device 816, which communicate with each other via a bus 808.

Processing device 802 represents one or more general-purpose processing devices such as a microprocessor, central processing unit, or the like. More particularly, the processing device 802 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 802 may also be one or more special-purpose processing devices such as an application specific integrated circuit (ASIC), a field programmable gate array (FPGA), a digital signal processor (DSP), network processor, or the like. The processing device 802 is configured to execute instructions 826 for implementing the field detection engine 111 and/or the training engine 151 of FIG. 1 and to perform the operations and steps discussed herein (e.g., methods 600-700 of FIGS. 6-7).

The computer system 800 may further include a network interface device 822. The computer system 800 also may include a video display unit 810 (e.g., a liquid crystal display (LCD) or a cathode ray tube (CRT)), an alphanumeric input device 812 (e.g., a keyboard), a cursor control device 814 (e.g., a mouse), and a signal generation device 820 (e.g., a speaker). In one illustrative example, the video display unit 810, the alphanumeric input device 812, and the cursor control device 814 may be combined into a single component or device (e.g., an LCD touch screen).

The data storage device 816 may include a computer-readable medium 824 on which is stored the instructions 826 embodying any one or more of the methodologies or functions described herein. The instructions 826 may also reside, completely or at least partially, within the main memory 804 and/or within the processing device 802 during execution thereof by the computer system 800, the main memory 804 and the processing device 802 also constituting computer-readable media. In some embodiments, the instructions 826 may further be transmitted or received over a network via the network interface device 822.

While the computer-readable storage medium 824 is shown in the illustrative examples to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

Although the operations of the methods herein are shown and described in a particular order, the order of the operations of each method may be altered so that certain operations may be performed in an inverse order or so that certain operation may be performed, at least in part, concurrently with other operations. In certain implementations, instructions or sub-operations of distinct operations may be in an intermittent and/or alternating manner.

It is to be understood that the above description is intended to be illustrative, and not restrictive. Many other implementations will be apparent to those of skill in the art upon reading and understanding the above description. The scope of the disclosure should, therefore, be determined with reference to the appended claims, along with the full scope of equivalents to which such claims are entitled.

In the above description, numerous details are set forth. It will be apparent, however, to one skilled in the art, that the aspects of the present disclosure may be practiced without these specific details. In some instances, well-known structures and devices are shown in block diagram form, rather than in detail, in order to avoid obscuring the present disclosure.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “receiving,” “determining,” “selecting,” “storing,” “analyzing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general purpose computer selectively activated or reconfigured by a computer program stored in the computer. Such a computer program may be stored in a computer-readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear as set forth in the description. In addition, aspects of the present disclosure are not described with reference to any particular programming language. It will be appreciated that a variety of programming languages may be used to implement the teachings of the present disclosure as described herein.

Aspects of the present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read-only memory (“ROM”), random access memory (“RAM”), magnetic disk storage media, optical storage media, flash memory devices, etc.).

The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Furthermore, the terms “first,” “second,” “third,” “fourth,” etc. as used herein are meant as labels to distinguish among different elements and may not necessarily have an ordinal meaning according to their numerical designation.

Whereas many alterations and modifications of the disclosure will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims, which in themselves recite only those features regarded as the disclosure.

What is claimed is:

1. A method, comprising:
extracting a plurality of features from an electronic document, the plurality of features comprising a plurality of symbolic vectors representative of words in the image;
processing the plurality of features using a neural network;
detecting, by a processing device, a plurality of text fields in the electronic document based on an output of the neural network; and
assigning, by the processing device, each of the plurality of text fields to one of a plurality of field types based on the output of the neural network.

2. The method of claim 1, wherein extracting the plurality of features of the electronic document comprises:
recognizing text in the image of the electronic document;
dividing the recognized text in the image into the words;
extracting a plurality of character sequences from the words; and
extracting the plurality of symbolic vectors from the plurality of character sequences.

3. The method of claim 2, wherein extracting the plurality of character sequences from the words comprises:
extracting a first plurality of characters and a second plurality of characters from each of the words, the first plurality of characters corresponding to the second plurality of characters in a reverse order.

4. The method of claim 1, wherein processing the plurality of features using the neural network comprises:
processing, by a first plurality of layers of the neural network, the plurality of character sequences to extract the first plurality of feature vectors representative of the words in the electronic document.

5. The method of claim 4, wherein the first plurality of feature vectors comprises a plurality of word embeddings.

6. The method of claim 4, wherein processing the plurality of features using the neural network comprises:
processing, by a second plurality of layers of the neural network, the plurality of features extracted from the electronic document to build at least one first table of a first plurality of word features based on the first plurality of feature vectors and a second plurality of feature vectors representative of the words in the electronic document.

7. The method of claim 6, wherein the second plurality of feature vectors comprises at least one of a plurality of word vectors in an embedding dictionary or a plurality of word vectors in a keyword dictionary.

8. The method of claim 6, wherein the second plurality of feature vectors comprises spatial information of a plurality of portions of the electronic document containing the words, and wherein each of the plurality of portions of the electronic document corresponds to one of the words.

9. The method of claim 6, wherein processing the plurality of features using the neural network comprises:
constructing, using a third plurality of layers of the neural network, a pseudo-image based on the at least one first table of the first plurality of word features, wherein the pseudo-image comprises spatial information indicative of locations of the text fields in the electronic document; and
processing the pseudo-image using a fourth plurality of layers of the neural network to extract a second plurality of word features representative of the words in the electronic document.

10. The method of claim 9, wherein processing the pseudo-image by the fourth plurality of layers of the neural network comprises performing semantic segmentation on the pseudo-image.

11. The method of claim 9, further comprising constructing at least one second table including the second plurality of word features.

12. The method of claim 8, wherein processing the plurality of features using the neural network further comprises:
classifying, by a fifth layer of the neural network, each of the words into one of a predetermined classes based on the second plurality of word features, wherein each of the predefined classes corresponds to one of the field types.

13. A system comprising:
a memory; and
a processing device operatively coupled to the memory, the processing device to: extract a plurality of features from an electronic document, the plurality of features comprising a plurality of symbolic vectors representative of words in the electronic document;
process the plurality of features using a neural network;
detect a plurality of text fields in the electronic document based on an output of the neural network; and
assign each of the plurality of text fields to one of a plurality of field types based on the output of the neural network.

14. The system of claim 13, wherein, to process the plurality of features using the neural network, the processing device is further to:
process, using a first plurality of layers of the neural network, the plurality of character sequences to extract the first plurality of feature vectors representative of the words in the electronic document.

15. The system of claim 14, wherein, to process the plurality of features using the neural network, the processing device is further to:
process, using a second plurality of layers of the neural network, the plurality of features extracted from the electronic document to build at least one first table of a first plurality of word features based on the first plurality of feature vectors and a second plurality of feature vectors representative of the words in the electronic document.

16. The system of claim 15, wherein to process the plurality of features using the neural network, the processing device is further to:
construct, using a third plurality of layers of the neural network, a pseudo-image based on the at least one first table of the first plurality of word features, wherein the pseudo-image comprises spatial information indicative of locations of the text fields in the electronic document; and
process the pseudo-image using a fourth plurality of layers of the neural network to extract a second plurality of word features representative of the words in the electronic document.

17. The system of claim 16, wherein, to process the pseudo-image using the fourth plurality of layers of the neural network, the processing device is further to perform semantic segmentation on the pseudo-image using the fourth plurality of layers of the neural network.

18. The system of claim 16, wherein the processing device is further to construct at least one second table including the second plurality of word features.

19. The system of claim 16, wherein, to process the plurality of features using the neural network, the processing device is further to:
classify, using a fifth layer of the neural network, each of the words into one of a predetermined classes based on the second plurality of word features, wherein each of the predefined classes corresponds to one of the field types.

20. A non-transitory machine-readable storage medium including instructions that, when accessed by a processing device, cause the processing device to:
extract a plurality of features from an electronic document, the plurality of features comprising a plurality of symbolic vectors representative of words in the electronic document;
process the plurality of features using a neural network;
detect a plurality of text fields in the electronic document based on an output of the neural network; and
assign each of the plurality of text fields to one of a plurality of field types based on the output of the neural network.
